(19) United States
(12) Patent Application Publication
(10) Pub. No.: US 2001/0034406 A1
(43) Pub. Date: Oct. 25, 2001

(54) Water-soluble thermosetting resin and wet-strength agent for paper using the same

(76) Inventors: Satoshi Yamamoto, Toyonaka-shi (JP); Yoshifumi Yoshida, Toyonoka-shi (JP); Masahiko Kurumatani, Oaska-shi (JP); Mika Ota, Itami-shi (JP); Satoshi Asano, Toyonaka-shi (JP)

Correspondence Address: Thomas P. Pavelko, Esquire, STEVENS, DAVIS , MILLER & MOSHER, L.L.P., Suite 850, 1615 L Street, N.W., Washington, DC, 20036, US

(21) Appl. No.: 09/739,887

(22) Filed: Dec. 20, 2000

(30) Foreign Application Priority Data
Dec. 21, 1999 (JP) 11-362404
Jul. 12, 2000 (JP) 2000-211002

(51) Int. Cl. C08L 77/00; C08L 77/06; C08L 63/00; C08J 3/03; C08G 69/00; C08G 69/26; C08G 69/48

(52) U.S. Cl. 524/845; 523/402; 523/426; 525/423; 525/430; 528/332; 528/341

(57) ABSTRACT

A water-soluble thermosetting resin giving high wet-strength of paper and excellent preservation stability which comprises 20% by weight or less of components having a molecular weight of 10,000 or less; and a water-soluble thermosetting resin giving high wet-strength of paper in which, in a reverse mutation test carried out for the resin as the object to be tested using histidine-requiring Salmonella typhimurium TA1535 strain, the number of reversant colonies generated is less than twice the number of reversant colonies in the solvent control, treated only the solvent as a reference liquid are provided; and a process for producing an aqueous cationic thermosetting resin solution giving excellent preservation stability of the solution which comprises a step of reacting polyamidepolyamine and epihalohydrin, and a step wherein the solution obtained by reacting polyamidepolyamine and epihalohydrin is held at a temperature of about 30 to about 70° C. for a period, while adjusting the pH to about 2 to about 3.8 is also provided.

### BACKGROUND OF THE INVENTION

The present invention relates to a water-soluble thermosetting resin, a method for producing an aqueous solution of the water-soluble thermosetting resin and a wet-strength agent for paper using the same.

Conventionally, various types of water-soluble resins in the form of aqueous solutions are available and used in the industries. For example, as an agent for enhancing the wet-strength of paper, that is, a wet-strength agent for paper, water-soluble thermosetting resins such as polyamidepolyamine-epihalohydrin resins are reported in JP-B-58-53653 (corresponding U.S. Pat. No. 4,287,110), and JP-A2-170825 and JP-A-9-278880.

In recent years, attempts have been made to further improve the quality of paper. For this purpose, a wet-strength agent for paper that imparts higher wet-strength to paper is desired.

The inventors of the present invention have attempted to improve the wet-strength of paper by increasing the molecular weight of a water-soluble thermosetting resin. However, it was found that, when the molecular weight of the resin is increased and an aqueous solution of the resin contained the resin in a high concentration, the solution was gelled during preservation, that is, the preservation stability was low.

For development of a water-soluble thermosetting resin that provides high wet-strength of paper and has excellent preservation stability, the inventors have intensively examined the molecular weight distributions of water-soluble thermosetting resins. As a result, they have found that a water-soluble thermosetting resin containing low molecular weight components in an amount equal to or less than a specific value exhibited excellent preservation stability and provided high wet-strength of paper.

The inventors also carried out reverse mutation tests for wet-strength agents for paper as objects to be tested using specific tester bacterial strains. They have unexpectedly found that high wet-strength of paper could be provided by a wet-strength agent for paper that exhibited the results of the reverse mutation test not exceeding a predetermined level.

### SUMMARY OF THE INVENTION

The present invention provides a water-soluble thermosetting resin that contains 20% by weight or less of components having a molecular weight of 10,000 or less.

The present invention also provides a water-soluble thermosetting resin in which, in a reverse mutation test carried out for the resin as the object to be tested using histidine-requiring Salmonella typhimurium TAI 535 strains, the number of reversant colonies generated is less than twice the number of revertant colonies in the solvent control, treated only the solvent as a reference liquid.

### EMBODIMENTS OF THE INVENTION

Specific examples of the water-soluble thermosetting resin of the invention include polyamidepolyamine-epihalohydrin resin and the like.

Hereinafter, the water-soluble thermosetting resin of the invention will be explained using the polyamidepolyamine-epihalohydrin resin as an example. The polyamidepolyamine-epihalohydrin resin can be produced, for example, by processes described in JP-B-58-53653, and JPA-2-170825 and JP-A-9-278880. In the processes, polyamidepolyamine is reacted with epihalohydrin to obtain a crude aqueous solution of polyamidepolyamine-epihalohydrin resin.

Examples of polyamidepolyamine used for producing the polyamidepolyamine-epihalohydrin resin include condensates of dicarboxylic acids and polyalkylenepolyamines.

The dicarboxylic acids used as the raw material include not only free acids but also derivatives thereof having reactivity with polyalkylenepolyamine, such as esters and acid anhydrides thereof. Examples of the dicarboxylic acids include: aliphatic dicarboxylic acids such as malonic acid, succinic acid, glutaric acid, adipic acid, and sebacic acid; aromatic dicarboxylic acids such as phthalic acid, isophthalic acid, and terephthalic acid; dicarboxylic esters such as diethyl malonate, dimethyl adipate, and dimethyl terephthalate; dicarboxylic anhydrides such as succinic anhydride, glutaric anhydride, and phthalic anhydride; and dicarboxylic acid halides such as adipic acid chloride. A mixture of two different kinds of dicarboxylic acids maybe used as the dicarboxylic acid. Among the above dicarboxylic acids, aliphatic dicarboxylic acids having about 3 to about 10 carbons are preferred. Among them, adipic acid is particularly preferred.

The polyalkylenepolyamine is a compound having two primary amino groups and at least one secondary amino group in a molecule where the primary amino groups and the secondary amino group are bonded together with alkylene. If two or more secondary amino groups exist, they are bonded together with alkylene. Specific examples of the polyalkylenepolyamine include diethylenetriamine, triethylenetetramine, tetraethylenepentamine, iminobispropylamine, 3-azahexanel 1 ,6-diamine, and 4,7-diazadecane-1,10-diamine. A mixture of two or more different kinds of polyalkylenepolyamines maybe used as the polyalkylenepolyamine. Among the above polyalkylenepolyamines, diethylenetriamine and triethylenetetramine are preferred.

In the polycondensation for producing the polyamidepolyamine, the dicarboxylic acid is used in an amount of about 0.9 to about 1.4 equivalent, preferably about 0.9 to about 1. 2 equivalent, with respect to 1 equivalent of the primary amino group (terminal amino group) of the polyalkylenepolyamine.

In the polycondensation, amino carboxylic acids, diamines, α, β-unsaturated carboxylic acids, and the like may be added within a range of amounts that will not lower the wet-strength of paper. The amino carboxylic acids are compounds having both an amino group and a carboxylic group in a molecule. The amino carboxylic acids include not only the compounds themselves, but also derivatives thereof that are reactive with dibasic carboxylic acid compounds and/or polyalkylenepolyamine, such as those in which the carboxylic group has been esterified or bonded with the amino in the molecule. Examples of the amino carboxylic acids include: amino carboxylic acids such as glycine, alanine, and amino kapronic acid, esters thereof, and acid halides thereof, and lactams such as caprolactam. Examples of the diamines include ethylenediamine, 1,3-propanediamine, 1,4-butanediamine, and 1, 6-hexanediamine. Examples of the α,β-unsaturated carboxylic acids include acrylic acid, methacrylic acid, crotonic acid, esters thereof, and acid halides thereof.

Polyamidepolyamine is produced in the following manner, for example. A dicarboxylic acid and a polyalkylenepolyamine are subjected to polycondensation under atmospheric pressure or a reduced pressure at about 50 to about 250° C., preferably about 130 to about 200° C., while discharging water, alcohol, and the like generated. This polycondensation is continued until the viscosity at 25° C. of an aqueous solution of the reaction solution diluted to have a solid-concentration of 50% by weight reaches about 100 mPa·s or more, preferably about 400 to about 1000 mPa·s.

In the polycondensation, mineral acids and sulfonic acids may be used as a catalyst. Examples of the mineral acids include hydrochloric acid, sulfuric acid, nitric acid, and phosphoric acid. Examples of the sulfonic acids include benzene sulfonic acid and paratoluene sulfonic acid. Among these acids, sulfuric acid and sulfonic acids are preferred. When the catalyst is used, the amount is normally about 0.005 to about 0.1 equivalent, preferably 0.01 to 0.05 equivalent, with respect to 1 equivalent of polyalkylenepolyamine.

After termination of the polycondensation, the resultant polyamidepolyamine is normally diluted with water, and can be obtained in the form of an aqueous solution. The resultant aqueous solution is reacted with epihalohydrin, to obtain the aqueous polyamidepolyamine-epihalohydrin resin solution.

Examples of the epihalohydrin include epichlorohydrin and epibromhydrin. Epichlorohydrin is preferred.

The epihalohydrin is normally used in an amount of about 0.85 to about 2 equivalent, preferably about 0.95 to about 1.8 equivalent, with respect to 1 equivalent of the secondary amino group (amino group in a molecule) of the polyamidepolyamine. If the amount of epihalohydrin is less than 0.85 equivalent, the ability of enhancing the wetstrength of paper of the water-soluble thermosetting resin disadvantageously tends to decrease. If the amount exceeds 1.4 equivalent, the content of low molecular weight organic halogen compounds tends to increase in the aqueous polyamidepolyamine-epihalohydrin resin solution.

The reaction between polyamidepolyamine and epihalohydrin normally takes place in an aqueous solution. The sum of the concentrations of the polyamidepolyamine, the epihalohydrin, and the reaction product in the aqueous solution (% by weight, hereinafter this sum value is referred to as the reaction concentration) is normally about 10 to about 70% by weight, preferably about 25 to about 60% by weight. If the reaction takes place in the reaction concentration lower than 10% by weight, the reaction speed disadvantageously tends to decrease. If it takes place in the reaction concentration higher than 70% by weight, the reaction speed tends to increase, which is also disadvantageous because the aqueous polyamidepolyamine-epihalohydrin resin solution tends to be gelled.

The reaction between polyamidepolyamine and epihalohydrin normally takes place at a temperature of about 10 to about 80° C. Preferably, the reaction temperature is kept at about 10 to about 55° C., more preferably about 10 to about 45° C., until the epihalohydrin is consumed by about 70 to about 95% and the reaction time is within about seven hours. Thereafter the temperature is kept at about 25 to about 80° C., more preferably about 40 to about 70° C.

Once the epihalohydrin has been consumed by about 70 to about 95%, it is preferred to dilute the reaction solution so that the weight percentage of the reaction concentration is reduced by about five % or more but still equal to or more than about 20% by weight.

For example, when the reaction concentration is 30% by weight, the solution may be diluted so that the reaction concentration becomes 20 to 25% by weight. When the reaction concentration is 70% by weight, the solution may be diluted so that the reaction concentration becomes 20 to 65% by weight.

By the reaction described above, the polyamidepolyamine-epihalohydrin resin is obtained in the form of an aqueous solution. The reaction is preferably terminated when the viscosity at 25° C. of the aqueous solution that has a solid concentration of the reaction product of 25% by weight reaches about 50 to about 300 mPa·s, preferably about 70 to about 250 mPa·s.

If the viscosity does not reach 50 mPa·s, the ability of enhancing the wet-strength of paper disadvantageously tends to decrease. If the viscosity exceeds 300 mPa·s, foams are more likely to be generated during papermaking using the resin, which is also disadvantageous.

After the viscosity reaches a desired value described above and the reaction between polyamidepolyamine and epihalohydrin is terminated, an acid such as hydrochloric acid, sulfuric acid, phosphoric acid, formic acid, and acetic acid may be added to adjust the pH to about 2 to about 5, preferably about 2.5 to about 3.5, to obtain the aqueous polyamidepolyamine-epihalohydrin resin solution.

An alkylating agent may be added before, during, or after the reaction between polyamidepolyamine and epihalohydrin as described in JP-A-11-504966.

An example of the above process is as follows.

Polyamidepolyamine and epihalohydrin are reacted, and the reaction is terminated when the viscosity of a reaction solution reaches about 50 to about 300 mpa·s or the amount of unreacted epihalohydrin reaches about 10% or less, preferably about 5% or less, of the amount of epihalohydrin used. The resultant aqueous solution is reacted with an alkylating agent, such as halogenated hydrocarbons, halogenated acetic esters, chlorohydrins, halogen-free epoxy compounds, and alkyl sulfuric esters such as dimethyl sulfate and diethyl sulfate, in an amount of about 0. 1 to about 1. 0 equivalent, preferably about 0. 2 to about 0. 6 equivalent, with respect to 1 equivalent of the secondary amino group of the polyamidepolyamine.

Examples of the alkylating agent include: halogenated hydrocarbons such as methyl chloride, methyl bromide, methyl iodine, ethyl chloride, ethyl bromide, ethyl iodine, allyl chloride, benzyl chloride, and 2-chloroethyldimethylamine; halogenated acetic esters such as methyl chloracetate, methyl bromoacetate, ethyl chloracetate, and ethyl bromoacetate; chlorohydrins such as ethylene chlorohydrin, 3-chloro-2hydroxypropyltrimethyl ammonium chloride; epoxy compounds such as propylene oxide, glycidor, styrene oxide, and 1,2-epoxybutane; and alkyl sulfuric esters such as dimethyl sulfate and diethyl sulfate. Among those, halogenated hydrocarbons, halogenated acetic esters, halogen-free epoxy compounds, and alkyl sulfuric esters are preferred. Alkyl sulfuric esters are particularly preferred.

The reaction with the alkylating agent is normally carried out in an aqueous solution. The water content is preferably the same as, or higher than, the water content in the reaction between polyamidepolyamine and epihalohydrin.

The temperature at the reaction with the alkylating agent is normally about 10 to about 80° C., preferably about 30 to about 80° C., more preferably about 40 to about 70° C. The reaction temperature is preferably higher than the temperature in the reaction between polyamidepolyamine and epihalohydrin.

The aqueous solution of the water-soluble thermosetting resin obtained maybe used after concentrating the aqueous solution, or may be used after diluting the aqueous solution with water and the like. The water content of the wet-strength agent for paper is normally about 70 to about 90% by weight.

The pH of the wet-strength agent for paper is normally adjusted to about 2 to about 5, preferably about 2.5 to about 3.5, by adding an acid such as hydrochloric acid, sulfuric acid, phosphoric acid, formic acid, and acetic acid. The wet-strength agent for paper may also contain an antifoaming agent and the like.

The water-soluble thermosetting resin according to the invention can be used as an agent for improving the yield of a filler added during papermaking, a filtration improving agent used for increasing the speed of papermaking, and a precipitation flocculant for removing particulates included in drainage such as discharge liquor.

The water-soluble thermosetting resin such as the polyamidepolyamine-epihalohydrin resin described above normally has a weight-average molecular weight on the order of 100,000 to 2,000,000 and a number-average molecular weight on the order of 5,000 to 50,000. The resin normally contains more than 20% by weight of components having a molecular weight of 10,000 or less.

When the water-soluble thermosetting resin contains 20% by weight or less of components having a molecular weight of 10,000 or less, the crude aqueous solution of the resin may be used as the wet-strength agent for paper as it is. When the water-soluble thermosetting resin contains more than 20% by weight of components having a molecular weight of 10,000 or less, membrane separation or the like may be employed to obtain the water-soluble thermosetting resin of the invention. That is, membrane separation may be performed with a semipermeable membrane utilizing dialysis or osmosis phenomenon.

Examples of the membrane separation utilizing dialysis phenomenon include a dialysis method in which a dialysis membrane is used as the semipermeable membrane and the concentration difference between the two sides of the membrane is used as a propelling force to thereby separate low molecular weight components, and an electric dialysis method in which an ion exchange membrane is used as the semipermeable membrane and a potential difference is applied across the membrane to generate concentration difference between the two sides of the membrane to thereby separate low molecular weight components.

Examples of the dialysis method include a method in which a crude aqueous solution of the water-soluble thermosetting resin is placed to face water or the like with a dialysis membrane therebetween to allow low molecular weight components to move to the water through the dialysis membrane, and a method in which water is added to a crude aqueous solution of the water-soluble thermosetting resin and the solution is left to allow low molecular weight components to be discharged through a dialysis membrane.

Examples of the membrane separation utilizing the osmosis phenomenon include a reverse osmosis method and an ultrafiltration method, where a nano-filter membrane, a reverse osmosis membrane, an ultrafilter membrane, and the like are used as the semipermeable membrane, and a pressure is applied to one side of the membrane to separate low molecular weight components.

Examples of the reverse osmosis method include a method where a pressure of about 5 mPa or less is applied to separate low molecular weight components. The pressure is preferably about 0.1 to about 3 mPa. The concentration of solids in the crude aqueous solution of the water-soluble thermosetting resin is normally about 1 to about 50%. The concentration of solids may be increased by discharging water through the semipermeable membrane together with the low molecular weight components.

Water may be added during the membrane separation of the crude aqueous solution of the water-soluble thermosetting resin. Preferably, water may be added continuously during the membrane separation. The amount of added water is normally about ten times or less, preferably about five times or less, the total weight of the crude aqueous solution of the water-soluble thermosetting resin. If the amount of added water exceeds ten times, the time required for the membrane separation disadvantageously tends to be long.

When water is added continuously during the membrane separation, the water adding rate is preferably regulated so that the concentration of solids in the aqueous solution of the water-soluble thermosetting resin during the processing is normally about 5 to about 50% by weight, particlarly about 10 to about 30% by weight. If the concentration of solids exceeds 50% by weight, the viscosity of the aqueous water-soluble thermosetting resin solution increases. This disadvantageously tends to decrease the separation rate. If the concentration of solids is less than 5% by weight, also, the separation rate disadvantageously tends to decrease. When water is added, an amount of water roughly equal to or larger than the amount of water added is preferably discharged by filtration. As an effective method, water may be added during the filtration at roughly the same rate as the filtration rate at which liquid permeates and is discharged, so that the concentration of the solution does not change between before and after the filtration.

The semipermeable membrane used for the membrane separation is normally made of any of natural, synthetic, and semi-synthetic polymer materials and the like. Examples of such materials include cellulose, acetylated cellulose, polypropylene, polystyrene, polyacrylonitrile, polyethylene fluoride, polyvinylidene fluoride, polyvinyl alcohol, polyester, polycarbonate, polysulfone, polyethersulfone, polyamide, and polyimide. Among these materials, preferred are polyacrylonitrile, polyvinylidene fluoride, polysulfone, polyethersulfone, polyamide, polyimide, and the like.

Examples of the semipermeable membrane include an asymmetric porous phase change membrane, an asymmetric phase change membrane, a composite membrane, and a drawn membrane, from the structural point of view.

The fractionation molecular weight of the semipermeable membrane is normally about 2,000 to about 100,000, preferably about 3,000 to about 50,000, more preferably about 5,000 to about 20,000, although it actually depends on the kind and molecular weight of the water-soluble thermosetting resin to be processed. If the fractionation molecular weight of the semipermeable membrane is less than 2,000, the time required for removal of low molecular weight components disadvantageously tends to increase. If it exceeds 100,000, the yield of the water-soluble thermosetting resin disadvantageously tends to decrease.

The membrane separation is normally carried out at a temperature of about 10 to about 70° C., preferably about 20 to about 60° C. If the temperature for the membrane separation is lower than 10° C., the separation rate disadvantageously tends to decrease. If it exceeds 70° C., the resin solution tends to be gelled and the ability of enhancing the wetstrength of paper of the resultant wet-strength agent for paper tends to decrease, which is also disadvantageous.

The configuration of a membrane separation apparatus is not specifically limited, but any of known membrane separation apparatuses may be used.

The thus-obtained aqueous solution of the watersoluble thermosetting resin normally has a concentration of solids of about 5 to about 50% by weight, and is diluted or concentrated by evaporation as required. Concentration by evaporation may be performed under atmospheric pressure or a reduced pressure. Preferably, it is performed under a reduced pressure of about 1 to about 50 kPa at about 20 to about 70° C.

The aqueous water-soluble thermosetting resin solution obtained by filtering the aqueous polyamidepolyamine-epihalohydrin resin solution may be diluted or concentrated as required. Dilution or concentration may be performed during the filtration as described above. Concentration by evaporation may be performed under atmospheric pressure or a reduced pressure. Preferably, it is performed under a reduced pressure of about 1 to about 50 kPa at about 20 to about 70° C.

The pH of the aqueous solution of the water-soluble thermosetting resin is adjusted to about 2 to about 5, preferably about 2.5 to about 3.5, as required, by adding an acid such as hydrochloric acid, sulfuric acid, phosphoric acid, formic acid, and acetic acid.

The content (% by weight) of low molecular weight compounds in the water-soluble thermosetting resin of the invention is measured in the following manner. An aqueous solution of the water-soluble thermosetting resin is separated with an ultrafilter membrane made of polyethersulf one having a fractionation molecular weight of 10,000. The peak area (a) of the aqueous solution before separation and the peak area (b) of the liquid that has permeated after separation are measured with a liquid chromatograph equipped with a RI detector. A value obtained from (b/a×100 (%)) is determined as the content of components having a molecular weight of 10,000 or less in the resin.

As a simple method for measuring the content of low molecular weight components, an area percentage method using gel permeation chromatography (GPC), for example, maybe used. In this simple method, the content is obtained by preparing a calibration curve based on the results of the above method for measuring the content of components having a molecular weight of 10,000 or less using the membrane separation.

The simple method using GPC is specifically performed in the following manner. The contents (% by weight) of components having a molecular weight of 10,000 or less are measured by the method using the membrane separation described above for a plurality of samples having different contents of components having a molecular weight of 10,000 or less. GPC measurement is then performed for the same samples to obtain the area percentages (%) of the components having a molecular weight of 10,000 or less. Based on the results of this measurement and the results of the contents of components having a molecular weight of 10,000 or less obtained using the membrane separation, a calibration curve is prepared. Then, the content of components having a molecular weight of 10,000 or less can be obtained from the area percentage of the components having a molecular weight of 10,000 or less obtained by GPC and the calibration curve.

The water-soluble thermosetting resin of the invention has a content of components having a molecular weight of 10,000 or less of 20% by weight or less by the above measurement method.

As mentioned above, the water-soluble thermosetting resin of the invention can be used as a wet-strength agent for paper, an agent for improving the yield of a filler added during papermaking, a filtration improving agent used for increasing the speed of papermaking, and a precipitation flocculant for removing particulates included in drainage such as discharge liquor. Especially preferred is the use as a wet-strength agent for paper.

The present invention also provides a water-soluble thermosetting resin, such as the polyamidepolyamine-epihalohydrin resin as described above, in which, in a reverse mutation test carried out for the resin as the object to be tested using histidine-requiring Salmonella typhimurium TA1535 strain, the number of revertant colonies generated is less than twice the number of revertant colonies in the solvent control, treated only by the solvent as reference liquid.

The back mutation test is carried out in the following manner. Tester strains lacking in the ability of synthesizing a specific amino acid such as histidine or tryptophan and thus requiring the specific amino acid to grow, are treated with a reference liquid such as sterilized water. The number of colonies of mutants that have resumed the ability of synthesizing the amino acid and thus no more requiring the amino acid to grow (the number of revertant colonies) is measured. The above tester strains are also treated with the water-soluble thermosetting resin solution, and the number of revertant colonies generated is measured. The ratio of the latter number of revertant colonies generated by the treatment with the water-soluble thermosetting resin to the former number of revertant colonies generated by the treatment with the reference liquid is determined.

A procedure for the reverse mutation test is described in “Mutagenicity Test in Industrial Safety and Health Law” edited by Japanese Ministry of Labour, Chemical Substances Investigation Division, pp. 40-63, Japan Industrial Safety and Health Association (1991), for example. Herein, as a specific method, a preincubation method in the reverse mutation test using histidine(his)-requiring Salmonella tvphimurium TA-1535 strain will be described.

First, a culture medium, including a nutrient broth (8 g/L) and sodium chloride (5 g/L) is autoclaved. An aliquot of TA-1535 strain are inoculated into the culture medium, and cultured at 37° C. shaking for about 6 to about 16 hours, preferably for 8 to 10 hours. The resultant solution is used as a test bacterial solution.

Next; 0. 1 ml of the test bacterial solution is put in a sterilized small test tube, together with a solution containing the water-soluble thermosetting resin in an amount of 0.01 to 0.2 ml, preferably 0.05 to 0.1 ml, and S9 mix in an amount of 0.5 ml.

A plurality of such test tubes are prepared so as to provide 6 to 12 different concentrations of the water-soluble thermosetting resin (solid content) in the test tubes in the range of about 50 to about 5000 fig per test tube.

The S9 mix is a solution containing a drug metabolism activating enzymes. A specific example of the S9 mix is comprised of a 100 mM of sodium phosphate buffer coenzymes (4 mM of NADPH, 4 mM of NADH, and 5 mM of glucose-6-phosphoric acid), 33 mM of KCl, 8 mM of MgCl and S9 prepared from livers of rats administered with phenobarbital and 5,6-benzoflavone. The concentration of S9 in the S9 mix is 10% by volume.

A test tube that does not contain the water-soluble thermosetting resin but only contains the solvent is also prepared as a solvent control.

As the solvent for the solvent control and for the water-soluble thermosetting resin, normally used are sterilized water, acetone, dimethyl sulfoxide, and the like. When the water-soluble thermosetting resin is in the form of an aqueous solution, sterilized water is used as the solvent.

The solutions in the test tubes are cultured at about 37° C. shaking for about 15 to about 60 minutes, preferably for about 20 to about 30 minutes. Thereafter, 2 ml of a soft agar solution kept at about 40 to about 50° C. is added to the test tubes. The resultant solutions in the test tubes are immediately poured onto agar flat-plate. Once the soft agar solidified, the plates are cultured in an incubator at about 37° C. for about 40 to about 65 hours, preferably about 48 hours.

The soft agar solution is obtained by, for example, mixing a sterilized aqueous solution containing 0.6% of agar and 0.5% of NaCl and a sterilized aqueous solution containing 0.5 mM of L-histidine and 0.5 mM of biotin at a ratio of 10:1.

The agar plate is obtained in the following manner, for example. A solution of

| | |
|---|---|
| distilled water | 900 ml |
| Vogel-Bonner minimal medium | 100 ml |
| (× 10 concentration) | |
| glucose (2.0%) | 20 g |
| agar (1.5%) | 15 g |

is autoclaved. The solution is dispensed to sterilized petri dishes by about 25 to about 30 m, and then the respective dispensed solutions are solidified.

The Vogel-Bonner minimal medium (×10 concentration) is normally obtained by dissolving 2 g of MgSO₄.7H₂O, 20 g of citric acid monohydrate, 100 g of dipotassium hydrogen phosphate, and 35 g of NaNH₄HPO₄ ·4H₂O in distilled water to obtain a solution of 1000 ml.

After the incubation, the numbers of revertant colonies generated in the respective plates are counted. The maximum value among the numbers of revertant colonies in the plates containing the water-soluble thermosetting resin in different concentrations is compared with the number of revertant colonies in the solvent control plate containing the reference liquid, and the ratio of the former to the latter is determined.

If the former is twice or more the latter, the ability of enhancing the wet-strength of paper of the water-soluble thermosetting resin disadvantageously tends to decrease.

It is preferred that the water-soluble thermosetting resin, particularly the water-soluble thermosetting resin in which, in a reverse mutation test carried out for the resin as the object to be tested using histidine-requiring Salmonella typhimurjum TA1535 strains, the number of reversant colonies generated is less than twice the number of reversant colonies in the solvent control, treated only the solvent as a reference liquid, further satisfies the following. The numbers of reversant colonies generated in the reverse mutation test using the resin as the object to be tested in histidine-requiring Salmonella typhimurium TA1537, TA100, TA98 strains, and a tryptophan-requiring Escherichia coli WP2uvrA strain, are all less than twice the numbers of reversant colonies containing of the solvent control treated with only the solvent.

According to the water-soluble thermosetting resin of the invention, the number of reversant colonies generated in the reverse mutation test using the resin as the object to be tested and TA1535 strains as the test strain is less than twice the number of reversant colonies in the solvent control treated with only the solvent.

The water-soluble thermosetting resin having the above feature provides high wet-strength of paper.

The inventors preserved an aqueous solution of the water-soluble thermosetting resin having a solid content of 25% obtained by reacting polyamidepolyamine and epihalohydrin, and found that the solution was gelled during preservation. This indicates that the solution is very poor in preservation stability when the solid content is high.

After intensive study on the aqueous water-soluble thermosetting resin solution obtained by reacting polyamidepolyamine and epihalohydrin, the inventors found that by holding the aqueous solution under the conditions of a specific pH and a specific temperature range for a period, the resultant aqueous water-soluble thermosetting resin solution exhibited excellent preservation stability even when the solid content of the solution was high.

That is, the present invention further provide a method for producing an aqueous cationic thermosetting resin solution obtained by reacting polyamidepolyamine and epihalohydrin, which comprises a step wherein a solution obtained by reacting polyamidepolyamine and epihalohydrin is held at a temperature of about 30 to about 70° C., preferably about 40 to about 60° C. for a period, while adjusting the pH to about 2 to about 3.8, preferably about 2.5 to about 3.5 by adding an acid or by other means.

If the holding temperature is higher than 70° C., the ability of enhancing the wet-strength of paper disadvantageously tends to decrease. If it is lower than 30° C., the preservation stability disadvantageously tends to decrease.

The period for holding temperature differs depending on the holding temperature, but normally about seven days at 30° C. , and about 12 to about 24 hours at 70° C. It is especially preferred to hold the solution for about 24 to about 72 hours when the temperature is about 40 to about 60° C.

The dialysis and concentration described above may be carried out during this temperature holding.

After the temperature holding period, the aqueous solution preferably has a solid content of about 10 to about 40% by weight, more preferably about 20 to about 30% by weight, and the pH is preferably adjusted to about 2.5 to about 3.8, more preferably to about 3.0 to about 3.5.

When the pH of the aqueous solution is below 2, it should be adjusted to fall within the above range using an inorganic base such as an alkali metal hydroxide, an alkali metal carbonate, an alkaline-earth metal hydroxide, an alkaline-earth metal carbonate, and ammonia, an organic base such as n-butylamine, diethylamine, and triethylamine, or the like.

The thus-obtained water-soluble thermosetting resin is usable as a wet-strength agent for paper. Paper containing the wet-strength agent for paper of the invention is excellent in the wet-strength of paper. The wet-strength agent for paper can be mixed in paper by adding the agent to pulp slurry, for example. Alternatively, paper may be impregnated with the agent using a size press, a gate roll coater, and the like. The method of adding the agent to pulp slurry is preferred.

The pulp slurry may be acid by being treated with aluminum sulfate, or neutral without treatment with aluminum sulfate.

A sizing agent such as reinforced/non-reinforced rosin, alkylketene dimer, and alkenyl or alkyl succinic acid anhydride may be added to the pulp slurry. Such a sizing agent may be added to the pulp slurry before or after the wetstrength agent for paper is added. Alternatively, the wet-strength agent for paper may be diluted and added to the sizing agent, and the resultant solution may be added to the pulp slurry.

The pulp slurry may also include: a filler such as clay, kaoline, calcium carbonate, barium sulfate, and titanium oxide; a sizing fixer; a dry paper strength agent; an antifoaming agent; a pH controller; a dye; and a fluorescent brightening agent, as required.

The basis weight of the paper made is normally about 10 to about 400 g/m³.

Hereinafter, the present invention will be described in more detail by way of examples. It should be noted that the present invention will not be restricted by these examples. The parts and percentages (%) in the examples are weight basis unless otherwise specified. The values of pH and viscosity are those measured at 25° C. The viscosity was measured with a Brookfield viscometer. In general, the polyamidepolyamine-epihalohydrin resin contains dihalohydrin in the largest amount among the low molecular weight organic halogen compounds. Accordingly, as a representative of low molecular weight organic halogen compound, dihalohydrin was quantified by gas chromatography.

### SYNTHESIS EXAMPLE 1

Diethyleneamine, 103 parts, 138.7 parts of adipic acid, 10 parts of water, and 2 parts of 98% sulfuric acid were put in a flask equipped with a thermometer, a Liebig cooler, and an agitation rod, and reacted at 155 to 160° C. for 15 hours while discharging the water. The resultant solution was added gradually with 210 parts of water to obatin an aqueous polyamidepolyamine solution having a solid concentration of 50.7% and a viscosity of 680 mPa·s.

Then, 1.29 parts of the aqueous polyamidepolyamine solution and 53.3 parts of water were put in another flask. While the temperature of the reaction solution was kept at 25-35° C., 33.3 parts of epichlorohydrin was added to the solution over 4 hours. While keeping the same temperature, the resultant mixture was stirred for 4 hours.

Thereafter, 60.8 parts of water was added to the resultant solution, and after being diluted to have a reaction concentration of 35%, the solution was heated to 40° C., and the reaction was conducted for 7 more hours at 40 to 60° C. Then, the solution was adjusted to pH 3.4 by sulfuric acid, and diluted to have a reaction concentration of 15% by adding water to obtain an aqueous solution having a viscosity of 38 mPa·s.

As a result, the weight-average molecular weight of the resin in the resultant solution was about 340,000.

### EXAMPLE 1

The aqueous solution, 2000 parts, obtained in Synthesis Example 1 was filtered with an ultrafilter membrane made of polyethersulfone having a fractionation molecular weight of 10,000 at room temperature under a pressure of 1 mPa while adding water at the same rate as the rate at which liquid permeated and was discharged, so that 1200 parts of liquid permeated and were discharged. Using a membrane of the same type as that described above, 930 parts of liquid were allowed to permeate and were discharged. The resultant solution was adjusted to pH 3.0 with sulfuric acid, and then adjusted to have a concentration of 25% by further adding water, to obtain an aqueous solution having a viscosity of 134 mPa·s.

The aqueous solution was diluted with a pH 3.0 phosphoric acid buffer solution, and then subjected to membrane separation with a centrifuge at 6000 rpm for 10 minutes using a filter made of polyethersulfone having a fractionation molecular weight of 10,000 (UFV4BGC25 manufactured by Millipore). The peak area (a) of the aqueous solution before separation and the peak area (b) of the liquid that had permeated after separation were measured by liquid chromatography, and the content of components having a molecular weight of 10,000 or less (b/a ×100) was determined, which was 18.7%.

The resultant aqueous solution was preserved at 50° C. for 28 days. No gellation was observed.

0069

(Analysis Conditions of Liquid Chromatography)

| | |
|---|---|
| Eluant: | pH 3.0 phosphoric acid buffer solution |
| Flow of eluant: | 1.0 ml/min |
| Column: | TSKgel (manufactured by TOSOH) G6000PWXL + |
| | G3000PWXL + G2500PWXL |
| Detector: | RI detector |
| Example 2 | |

The aqueous solution, 2000 parts, obtained in Synthesis Example 1 was filtered with an ultrafilter membrane made of polyethersulfone having a fractionation molecular weight of 10,000 at room temperature under a pressure of 1 mPa while adding water at the same rate as the rate at which liquid permeated and was discharged, so that 4000 parts of liquid permeated and were discharged. As a result, an aqueous water-soluble thermosetting resin solution having a solid content of 11.4% was obtained. The content of components having a molecular weight of 10,000 or less was determined in the manner described in Example 1, which was 12.5%.

The resultant aqueous solution was concentrated by evaporation at 30 to 40° C. under a reduced pressure of 2 to 4 kPa, and then adjusted to pH 3.0 with sulfuric acid, to obtain an aqueous solution having a solid content of 24.9%. The aqueous resin solution was preserved at 50° C. No gellation was observed after 28 days.

### COMPARATIVE EXAMPLE 1

The content of components having a molecular weight of 10,000 or less in the aqueous solution obtained in Synthesis Example 1 was determined in the manner described in Example 1, and it was 25.7%. This aqueous solution, adjusted to have a concentration of 25%, was preserved at 50° C. As a result, gellation (whitening) was observed after three days.

### EXAMPLE 3

(Papermaking)

Using each of the aqueous resin solutions obtained in Examples 1 and 2 as the wet-strength agent for paper, papermaking was carried out under the following conditions according to the TAPPI standard papermaking method. For comparison, the same test was also carried out without an aqueous resin solution, and using the aqueous resin solutions obtained in Synthesis Examples 1. The wet breaking length of the resultant paper for each case was measured according to JIS P 8135. The results are shown in Table 1 below.

Papermaking Conditions

| | |
|---|---|
| Pulp used: | N-BKP/L-BKP = 1/1 |
| Degree of beating: | 400 cc |
| Resin added amount: | 0.3% (solid content, in dry pulp) |
| Drying condition: | 110° C., 4 minutes |

Average basis weight of paper: 60 g/m²

TABLE 1
Aqueous resin solution

| | | | |
|---|---|---|---|
| | | | Wet breaking length |
| Example No. | Content*1 | gellation time*2 | of paper |

Resin of the Invention

| | | | | |
|---|---|---|---|---|
| Example 1 | 18.7% | >28 days | 1.41 | km |
| Example 2 | 12.5% | >28 days | 1.48 | km |

Comparative Example

| | | | | |
|---|---|---|---|---|
| No resin*3 | — | — | 0.07 | km |
| Synthesis Example | 15.0% | 3 days | 1.31 | |

*1: Content of the component having the molecular weight of 10,000 or less
*2: Period when gellation was observed
*3: Paper making was carried without using an aqueous resin solution.

### SYNTHESIS EXAMPLE 2

Diethyleneamine, 413 parts (4.0 mol), 555 parts (3.8 mol) of adipic acid, 20 parts of water, and 8 parts (0.08 mol) of 98% sulfuric acid were put in a 1 L four-neck flask equipped with a thermometer, a reflux cooler, and an agitation rod, and reacted at 150 to 160° C. for 15 hours while discharging the water. The resultant solution was adjusted to have a concentration of 50% by adding water, to obtain an aqueous polyamidepolyamine solution having a viscosity of 680 mpa·s. Then, 1,290 parts of the aqueous 50% polyamidepolyamine solution (3.0 mol as diethylenetriamine) and 1,170 parts of water were put in another flask. While the temperature inside the flask was kept at 30° C. or below, 333 parts (3.6 mol) of epichlorohydrin was added to the solution. The resultant solution was held at 30 to 35° C. for four hours, then heated, and held again at 60 to 65° C. Once the viscosity reached 400 mpa·s, the solution was adjusted to pH 3.4 and diluted ho have a concentration of 15% by adding water. As a result, an aqueous resin solution having a viscosity of 40 mPa·s was obtained.

The molecular weight of the resultant resin was measured by gel permeation chromatography(GPC). As a result, the weight-average molecular weight was 340,000 in terms of polyethylene glycol.

### SYNTHESIS EXAMPLE 3

The aqueous 50% polyamidepolyamine solution, 129 g (0.3 mol as diethylenetriamine), synthesized at the first stage of Synthesis Example 2 and 118 g of water were mixed, and 44 g (0.48 mol) of epichlorohydrin was added. The resultant solution was held at 60 to 65° C. Once the viscosity reached 450 mPa·s, the solution was adjusted to pH 3.6 with sulfuric acid and diluted to have a concentration of 25% by adding water. As a result, an aqueous resin solution having a viscosity of 185 mPa·s was obtained.

### SYNTHESIS EXAMPLE 4

The aqueous polyamidepolyamine-epihalohydrin resin solution, 2000 parts, obtained in Synthesis Example 2 was filtered with a filter membrane made of polyethersulfone having a fractionation molecular weight of 10,000 at room temperature under a pressure of 1 mPa by ultrafilter membrane separation while adding water at the same rate as the rate at which liquid permeated and was discharged, so that 1200 parts of liquid permeated and were discharged. Thereafter, reverse osmosis membrane separation was performed with a filter membrane made of polyethersulfone having a fractionation molecular weight of 10,000 at room temperature under a pressure of 1 mPa, so that 930 parts of liquid permeated and were discharged. The resultant solution was adjusted to pH 3.0 with sulfuric acid, and then adjusted to have a nonvolatile content of 25% by further adding water. As a result, an aqueous polyamidepolyamine-epihalohydrin resin solution (wet-strength agent for paper) having a viscosity of 136 mPa·s was obtained.

### SYNTHESIS EXAMPLE 5

The aqueous polyamidepolyamine-epihalohydrin resin solution, 2000 parts, obtained in Synthesis Example 2 was filtered with a filter membrane made of polyethersulfone having a fractionation molecular weight of 10,000 at room temperature under a pressure of 1 mPa by ultrafilter membrane separation while adding water at the same rate as the rate at which liquid permeated and was discharged, so that 4000 parts of liquid permeated and were discharged. As a result, an aqueous polyamidepolyamine-epihalohydrin resin solution (wet-strength agent for paper) having a nonvolatile content of 11.4% was obtained.

### SYNTHESIS EXAMPLE 6

The aqueous polyamidepolyamine-epihalohydrin resin solution, 2000 parts, obtained in Synthesis Example 2 was filtered with a filter membrane made of polyethersulfone having a fractionation molecular weight of 10,000 at room temperature under a pressure of 1 mPa by ultrafilter membrane separation while adding water at the same rate as the rate at which liquid permeated and was discharged, so that 2500 parts of liquid permeated and were discharged. As a result, an aqueous polyamidepolyamine-epihalohydrin resin solution (wet-strength agent for paper) having a nonvolatile content of 12.3% was obtained.

### SYNTHESIS EXAMPLE 7

The aqueous polyamidepolyamine-epihalohydrin resin solution, 2000 parts, obtained in Synthesis Example 2 was filtered with a filter membrane made of polyethersulfone having a fractionation molecular weight of 10,000 at room temperature under a pressure of 1 mPa by ultrafilter membrane separation while adding water at the same rate as the rate at which liquid permeated and was discharged, so that 1400 parts of liquid permeated and were discharged. As a result, an aqueous polyamidepolyamine-epihalohydrin resin solution (wet-strength agent for paper) having a nonvolatile content of 13.2% was obtained.

(Reverse Mutation Test)

A test bacterial solution obtained by culturing histidine-requiring Salmonella typhimurium TA1535 strains for nine hours was dispensed into sterilized small test tubes by 0.1 ml. Subsequently, an aqueous solution of the polyamidepolyamine-epihalohydrin resin was dispensed into the test tubes by 0.1 ml so that the amount of the polyamidepolyamine-epihalohydrin resin (solid content) per test tube was 0,78.1, 156,313,625, 1250,2500, and 5000 μg/plate. Thereafter, 0.5 ml of S9 mix was added to each test tube and cultured at 37° C. with shaking for 20 minutes. A soft agar solution, 2 ml, kept at about 45° C. was then added. The resultant liquid in each test tube was immediately poured onto an agar plate and left to solidify the soft agar. The solidified plate was inverted and cultured at 37° C. for 48 hours, and the number of revertant colonies generated was counted. The maximum value among the numbers of revertant colonies in the above plates containing the polyamidepolyamine-epihalohydrin resin was compared with the number of revertant colonies in the plate containing no polyamidepolyamine-epihalohydrin resin, and the ratio of the former to the latter was determined. The results are shown in Table 2.

Table 2 also shows the results of the reverse mutation test carried out in the manner described above using histidine(his)-requiring Salmonella typhimurium TA1537, TA100, and TA98 strains and tryptophan(trp)-requiring Escherichia coli WP2uvrA strain.

### EXAMPLES 3-5, COMPARATIVE EXAMPLES 2-5

Using each of the aqueous resin solutions obtained in Synthesis examples 2-7, a paper-making test was carried out according to the TAPPI standard papermaking method. The wet breaking length of the resultant paper for each case was measured according to JIS P 8135. The results are shown in Table 2 below.

Papermaking Conditions

| | |
|---|---|
| Pulp used: | N-BKP/L-BKP = 1/1 |
| Degree of beating: | 400 cc |
| Resin added amount: | 0.3% (solid content, in dry pulp) |
| Drying condition: | 110° C., 4 minutes |

Average basis weight of paper: 60 g/m²

TABLE 2

| | aqueous | Reverse mutation test (Ratio of the resin | | | | | Wet |
|---|---|---|---|---|---|---|---|
| | resin | treated group to the solvent control) | | | | | breaking |
| Example | solution | TA | TA | | TA | WP2 | length of |
| No. | #1 | 1535 | 110 | TA98 | 1537 | uvrA | paper |

Examples of the Invention

| | | | | | | | |
|---|---|---|---|---|---|---|---|
| 3 | 4 | 1.2 | 0.9 | 0.9 | 0.4 | 1.4 | 1.22 km |
| 4 | 5 | 1.5 | — | — | — | — | 1.25 km |
| 5 | 6 | 1.9 | — | — | — | — | 1.18 km |

Comparative Example

| | | | | | | | |
|---|---|---|---|---|---|---|---|
| 2 | 2 | 2.7 | 1.1 | 1.4 | 2.3 | 1.2 | 1.07 km |
| 3 | 3 | 6.5 | 1.3 | 1.7 | 1.1 | 1.3 | 1.06 km |
| 4 | 7 | 3.0 | — | | — | — | 1.6 km |
| 5 | −*2 | — | — | — | — | — | 0.10 km |

*1: Expressed by the number of the synthesis example
*2 Paper making was carried without using an aqueous resin solution.

(Quantification of Dihalohydrin)

The content of 1,3-dichloro-2-propanol as dihalohydrin was quantified by gas chromatography.

(Solid Content)

The aqueous solution of the water-soluble thermosetting resin was put in a container, and dried for three hours with a 105° C. air dryer while the container was left unsealed. The dried residue in the container was then measured, and the percentage of the residue in the total weight of the aqueous solution put in the container was determined as the solid content of the aqueous

### SYNTHESIS EXAMPLE 8

Diethyleneamine, 103 parts, 138.7 parts of adipic acid, 10 parts of water, and 2 parts of 98% sulfuric acid were put in a flask equipped with a thermometer, a Liebig cooler, and an agitation rod, and reacted at 155 to 160° C. for 12 hours while discharging the water. The resultant solution was added gradually with 210 parts of water to obatin an aqueous polyamidepolyamine solution having a solid concentration of 50.8% and a viscosity of 690 mPa·s.

### SYNTHESIS EXAMPLE 9

Then, 1.29 parts of the aqueous polyamidepolyamine solution obtained in Synthesis Example 8 and 53.3 parts of water were put in another flask. While the temperature of the reaction solution was kept at 25-35° C., 30.5 parts of epichlorohydrin was added to the solution over 4 hours. While keeping the same temperature, the resultant mixture was stirred for 4 hours. Then, epichlorohydrin in the reaction solution was quantified and found that 2.44 parts of epichlorohydrin were left unreacted. In other words, 8% of epichlorohydrin used was left unreacted.

Thereafter, 60.8 parts of water was added to the resultant solution, and after being diluted to have a reaction concentration of 35%, the solution was heated to 60° C., and the reaction solution was stirred. After the temperature reached to 60° C., the solution was adjusted to pH 3.4 by sulfuric acid, and diluted by adding 117 parts of water to obtain an aqueous thermosetting resin solution having a viscosity of 123 mPa·s and solid content of 25.4%.

The content of 1,3-dichloro-2-propanol in the aqueous water soluble thermosetting resin solution was 2.6% with respect of the solid content of the thermosetting resin.

### EXAMPLE 6

The aqueous water soluble thermosetting resin solution obtained in Synthesis Example 9 was kept at 35-45° C. for 72 hours while keeping pH of the solution at 3.0 with sulfuric acid to obtain an aqueous thermosetting resin solution having a viscosity of 87 mPa·s and solid content of 25.8%. The content of dichlorohydrin in the aqueous water soluble thermosetting resin solution was 2.6% with respect of the solid content of the thermosetting resin. The aqueous resin solution was preserved at 50° C. No gellation was observed after 28 days.

0074

### EXAMPLE 7

The aqueous water soluble thermosetting resin solution obtained in Synthesis Example 9 was kept at 45-55° C. for 72 hours while keeping pH of the solution at 3.4 with sulfuric acid. Then, pH of the solution was adjusted to 3.0 with sulfuric acid. An aqueous thermosetting resin solution having a viscosity of 101 mPa-s and solid content of 25.8% was obtained. The content of 1 ,3-dichloro-2-propanol in the aqueous water soluble thermosetting resin solution was 2.5% with respect of the solid content of the thermosetting resin. The aqueous resin solution was preserved at 50° C. No gellation was observed after 28 days.

### EXAMPLE 8

The aqueous water soluble thermosetting resin solution obtained in Synthesis Example 9 was kept at 45-55° C. for 48 hours while keeping pH of the solution at 3.2 with sulfuric acid. Then, pH of the solution was adjusted to 3.0 with sulfuric acid. An aqueous thermosetting resin solution having a viscosity of 101 mPa·s and solid content of 25.8% was obtained. The content of 1 ,3-dichloro-2-propanol in the aqueous water soluble thermosetting resin solution was 2.5% with respect of the solid content of the thermosetting resin. The aqueous resin solution was preserved at 50° C. No gellation was observed after 28 days.

### EXAMPLE 9

To 300 parts of the aqueous water soluble thermosetting resin solution obtained in Synthesis Example 9,201 parts of water was added. The resultant solution was kept at 45-55° C. for 72 hours while keeping pH of the solution at 3.2 with sulfuric acid. Then, 260.4 parts of water was distilled out under a reduced pressure and pH of the solution was adjusted to 3.0 with sulfuric acid. An aqueous thermosetting resin solution having a viscosity of 70 mPa·s and solid content of 24.8% was obtained. The content of 1,3-dichloro-2-propanol in the solution was 1.8 % with respect of the solid content. The aqueous resin solution was preserved at 50° C. No gellation was observed after 28 days.

### COMPARATIVE EXAMPLE 6

The aqueous water soluble thermosetting resin solution obtained in Synthesis Example 9 was preserved at 50° C. Gellation was observed after 3 days.

### COMPARATIVE EXAMPLE 7

After adjusting the pH at 4.0, the aqueous water soluble thermosetting resin solution obtained in Synthesis Example 9 was kept at 45-55° C. without especially adjusting the pH of the solution thereafter. Gellation was observed after 72 hours. The pH after gellation was 4.3.

COMPARATIVE EXAMPLE 8

The aqueous water-soluble thermosetting resin solution was held at 15 to 25° C. for 120 hours without especially adjusting the pH. The resultant aqueous solution exhibited no change in the content of 1, 3-dichloro-2-propanol and the solid content, and had a viscosity of 128 mPa * s. This solution was preserved at 50° C. As a result, gellation was observed after 3 days.

Papermaking Test A

A papermaking test according to the TAPPI standard papermaking method under the papermaking conditions A was carried out using the aqueous resin solutions obtained in Examples 6 and 7 and Comparative examples 6-8. For comparison, the same test was also carried out without an aqueous resin solution, which is Comparative example 9. The wet breaking length of the resultant paper for each case was measured according to JIS P 8135. The results are shown in Table 3 below.

Papermaking Conditions A

| | |
|---|---|
| Pulp used: | N-BKP/L-BKP = 1/1 |
| Degree of beating: | 430 cc |
| Resin added amount: | 0.8% (solid content, in dry pulp) |
| Drying condition: | 110° C., 4 minutes |

Average unit weight of paper: 45 g/m²

TABLE 3

| Example | Keeping Conditions | | gellation | wet breaking |
|---|---|---|---|---|
| No. | Temperature | pH | time *1 | length of paper |

Example of the Invention

| | | | | | |
|---|---|---|---|---|---|
| 6 | 34-45° C. | 3.0 | >28 days | 1.65 | km |
| 7 | 45-55° C. | 3.4 | >28 days | 1.52 | km |

Comparative Examples

| | | | | | |
|---|---|---|---|---|---|
| 6 | — | — | 3 days | 1.54 | km |
| 7 | 45-55° C. | 4.0 | <3 days | —2* | |
| 8 | 15-25° C. | 3.4 | 3 days | —*2 | |
| 9*3 | — | — | — | 0.07 | km |

*1: Period when gellation was observed
*2: Papermaking was not carried out.
*3: Paper making was carried without using an aqueous resin solution.

Papermaking Test B

A papermaking test according to the TAPPI standard papermaking method under the papermaking conditions B was carried out using the aqueous resin solutions obtained in Examples 6 and 8. For comparison, the same test was also carried out without an aqueous resin solution, which is Comparative example 10. The wet breaking length of the resultant paper for each case was measured according to JIS P 8135. The results are shown in Table 4 below.

Papermaking Conditions B

| | |
|---|---|
| Pulp used: | N-BKP/L-BKP = 1/1 |
| Degree of beating: | 435 cc |
| Resin added amount: | 0.3% (solid content, in dry pulp) |
| Drying condition: | 11 0° C., 4 minutes |

Average unit weight of paper: 65 g/m²

TABLE 4

| Example | Keeping Conditions | | gellation | Wet breaking |
|---|---|---|---|---|
| No. | Temperature | pH | time *1 | length of paper |

Example of the Invention

| | | | | | |
|---|---|---|---|---|---|
| 6 | 35-45° C. | 3.0 | >28 days | 1.57 | km |
| 8 | 45-55° C. | 3.2 | >28 days | 1.55 | km |

Comparative Example

| | | | | |
|---|---|---|---|---|
| 10*2 | — | — | 0.08 | km |

*1: Period when gellation was observed
*2: Paper making was carried without using an aqueous resin solution.

(Quantification of Low Molecular Weight Organic Halogen Compound)

The contents of 1,3-dichloro-2-propanol and epichlorohydrin as low molecular organic halogen compounds were quantified by gas chromatography.

### EXAMPLE 10

Diethylenetriamine, 103 parts, 10 parts of water, 138.7 parts of adipic acid, and two parts of 98% sulfuric acid were put in a flask equipped with a thermometer, a Liebig cooler, and an agitation rod, heated while distilling water, and agitated for 12 hours while keeping the temperature at 155 to 160° C. Water, 210 parts, was then gradually added, to obtain an aqueous solution of polyamidepolyamine having a water content of 49.2% and a viscosity of 690 mPa·s.

The aqueous solution of polyamidepolyamine, 129 parts, and 51.2 parts of water were put in another flask. While the reaction solution was kept at 25 to 35° C., 30.5 parts of epichlorohydrin was dropped over four hours. The resultant solution was agitated for four hours while keeping the above temperature.

The epichlorohydrin in the reaction solution at this point was quantified and found that 1.22 parts of epichlorohydrin were left unreacted. In other words, 4% of epichlorohydrin used was left unreacted.

To the above reaction solution, 14.2 parts (0.3 equivalent) of diethyl sulfate was added, and the resultant solution was agitated for three hours while the temperature was kept at 35 to 45° C. Water, 66.6 parts, was then added to dilute the reaction solution to have a water content of 65%.

Thereafter, the reaction solution was gradually heated from 40° C. to reach 60° C. At this point, 101 parts of water was added because the viscosity was 130 mPa-s when the water content was 75% by weight. The pH was then adjusted to 3.4 with sulfuric acid. Thus, an aqueous solution of the water-soluble thermosetting resin having a water content of 75.4% was obtained.

The content of 1,3-dichloro-2-propanol in the aqueous solution of the water-soluble thermosetting resin was 1.5% with respect to the solid content of the water-soluble thermosetting resin. No epichlorohydrin was detected.

The resultant water-soluble thermosetting resin was preserved at 50° C. for 28 days. No gellation was observed.

### EXAMPLE 11

As in Example 10, 23.8 parts of diethyl sulfate was added to the aqueous solution obtained by reacting epichlorohydrin with the aqueous solution of polyamidepolyamine, and the resultant solution was agitated for three hours while the temperature was kept at 35 to 45° C. Water, 72.9 parts, was then added to dilute the reaction solution to have a water content of 65%.

Thereafter, the reaction solution was gradually heated from 40° C. to reach 60° C. At this point, 117 parts of water was added because the viscosity was 125 mPa·s when the water content was 75% by weight. The pH was then adjusted to 3.4 with sulfuric acid. Thus, an aqueous solution of the water-soluble thermosetting resin having a water content of 25.4% was obtained.

The content of 1,3-dichloro-2-propanol in the aqueous solution of the water-soluble thermosetting resin was 1. 5% with respect to the solid content of the water-soluble thermosetting resin. No epichlorohydrin was detected.

The resultant water-soluble thermosetting resin was preserved at 50° C. for 28 days. No gellation was observed.

Papermaking Test C

A papermaking test according to the TAPPI standard papermaking method under the papermaking conditions C was carried out using the aqueous resin solutions obtained in Examples 10 and 11. For comparison, the same test was also carried out without an aqueous resin solution, which is Comparative example 11. The wet breaking length of the resultant paper for each case was measured according to JIS P 8135. The results are shown in Table 5 below.

Papermaking Conditions C

| | |
|---|---|
| Pulp used: | N-BKP/L-BKP = 1/1 |
| Degree of beating: | 400 cc |
| Resin added amount: | 0.6% (solid content, in dry pulp) |
| Drying condition: | 110° C., 4 minutes |

Average unit weight of paper: 60 g/m²

TABLE 5

| Example No. | Wet breaking length of paper |
|---|---|
| Example 10 | 1.47 km |
| Example 11 | 1.43 km |
| Comparative | 0.06 km |
| Example 11*1 | |

*1 Paper making was carried without using an aqueous resin solution.

The water-soluble thermosetting resin of the invention can be used as a wet-strength agent for paper that imparts high strength to wet paper. The aqueous solution of the resin is excellent in preservation stability. In particular, the aqueous solution exhibits excellent preservation stability even when the concentration of solids in the solution is high.

Paper containing the wet-strength agent for paper of the invention can be used as various types of paper sheets including: sheets for printing/information such as diazo sensitive paper; wrapping sheets such as kraft paper and one-side glazed kraft paper; sanitary sheets such as tissue paper and paper towel; base paper for processing such as base paper for placage, wallcovering, food containers, and laminates; industrial hybrid sheets such as filter paper; home hybrid sheets such as tea bags; base paper of corrugated cardboards such as liners and corrugating media; base paper for construction materials such as plasterboards; base paper for paper pipes; newspaper webs; base paper for coating; and various printer sheets.

What is claimed is:

1. A water-soluble thermosetting resin which comprises 20% by weight or less of components having a molecular weight of 10,000 or less.

2. The water-soluble thermosetting resin according to claim 1, wherein the water-soluble thermosetting resin is polyamidepolyamine-epihalohydrin.

3. The water-soluble thermosetting resin according to claim 2, wherein the polyamidepolyamine-epihalohydrin resin is produced by reacting polyamidepolyamine with epihalohydrin and the polyamidepolyamine is produced by condensing a dicarboxylic acid and a polyalkylenepolyamine.

4. The water-soluble thermosetting resin according to claim 3, wherein the dicarboxylic acid is used in an amount of about 0.9 to about 1.4 equivalent with respect to 1 equivalent of the primary amino group of the polyalkylenepolyamine in producing the polyamidepolyamine.

5. The water-soluble thermosetting resin according to claim 1 wherein, production of the water-soluble thermosetting resin comprises a step of membrane separation performed with at least one semipermeable membrane selected from a nano filter membrane, a reverse osmosis membrane and an ultrafilter membrane.

6. The water-soluble thermosetting resin according to claim 5 wherein, the fractionation molecular weight of the semipermeable membrane is about 2,000 to about 100,000.

7. A water-soluble thermosetting resin in which, in a reverse mutation test carried out for the resin as the object to be tested using histidine-requiring Salmonella typhimurium TA1535 strain, the number of reversant colonies generated is less than twice the number of reversant colonies in the solvent control, treated only the solvent as a reference liquid.

8. The water-soluble thermosetting resin according to claim 7 wherein, the water-soluble thermosetting resin is polyamidepolyamine-epihalohydrin.

9. The water-soluble thermosetting resin according to claim 8 wherein, the polyamidepolyamine-epihalohydrin resin is produced by reacting polyamidepolyamine with epihalohydrin and the polyamidepolyamine is produced by condensing a dicarboxylic acid and a polyalkylenepolyamine.

10. The water-soluble thermosetting resin according to claim 9 wherein, the dicarboxylic acid is used in an amount of about 0.9 to about 1.4 equivalent with respect to 1 equivalent of the primary amino group of the polyalkylenepolyamine in producing the polyamidepolyamine.

11. The water-soluble thermosetting resin according to claim 7, which further satisfies that the numbers of reversant colonies generated in the reverse mutation test using the resin as the object to be tested and histidine-requiring Salmonella typhimurium TA1537, TA100 TA98 strains, and tryptophan-requiring Escherichia coli WP2uvrA strains are all less than twice the numbers of reversant colonies in the reverse mutation test using the reference liquid containing only the solvent.

12. A process for producing an aqueous cationic thermosetting resin solution which comprises a step of reacting polyamidepolyamine and epihalohydrin, and a step wherein the solution obtained by reacting polyamidepolyamine and epihalohydrin is held at a temperature of about 30 to about 70° C. for a period, while adjusting the pH to about 2 to about 3.8.

13. The process for producing an aqueous cationic thermosetting resin according to claim 12, wherein the solution is held at a temperature of about 40 to about 60° C. for about 24 to about 72 hours.

14. The process for producing an aqueous cationic thermosetting resin according to claim 12, wherein the polyamidepolyamine is produced by condensing an aliphatic dicarboxylic acid and a polyalkylenepolyamine.

15. The water-soluble thermosetting resin according to claim 14, wherein the aliphatic dicarboxylic acid is used in an amount of about 0.9 to about 1.4 equivalent with respect to 1 equivalent of the primary amino group of the polyalkylenepolyamine in producing the polyamidepolyamine.

16. An aqueous cationic thermosetting resin produced by the process according to claim 12 and has a solid content of about 10 to about 40% by weight and pH at about 2.5 to about 3.8.
